(19) United States
(12) Patent Application Publication
(10) Pub. No.: US 2010/0265706 A1
(43) Pub. Date: Oct. 21, 2010

(54) ADJUSTABLE CONDENSER SEAT

(75) Inventors: Chen-lun Hsing Chen, Ping Chen (TW); Jung-hao Hung, Ping Chen (TW); Shih-hsun Chung, Ping Chen (TW)

Correspondence Address: AUSTIN RAPP & HARDMAN, 170 South Main Street, Suite 735, SALT LAKE CITY, UT, 84101, US

(73) Assignee: ProLight Opto Technology Cooperation, Taoyuan Hsien (TW)

(21) Appl. No.: 12/547,737

(22) Filed: Aug. 26, 2009

(30) Foreign Application Priority Data
Apr. 21, 2009 (TW) 098113243

(51) Int. Cl. F21V 1/00

(52) U.S. Cl. 362/235; 362/285

(57) ABSTRACT

An adjustable condenser seat includes at least one light source, at least one lens, at least one lens sleeve, and at least one adjuster. The lens sleeve contains the lens which is disposed for the light source correspondingly for guiding light from the light source to the lens. The adjuster is disposed at a focal axis of the light between the light source and the lens sleeve. The adjuster is utilized for lengthening or shortening a distance between the light source and the lens so that a relative position between the light source and the lens can be adjusted. Accordingly, either a condensing angle of the lens or a focal position of the lens to the light source can be changed.

### BACKGROUND OF THE INVENTION

1. Claim of Priority

This application claims priority to Taiwanese Patent Application No. 098113243 filed on Apr. 21, 2009.

2. Field of the Invention

The present invention generally relates to a condenser seat, and more particularly to an adjustable condenser seat capable of changing a condensing angle of a lens or realizing a correct focus of the lens corresponding to a light source.

3. Description of Prior Art

For light to be projected farther, a general lamp often uses a collimator lens 21a (shown in FIG. 8), a condenser cup 22b (shown in FIG. 9), or a convex lens 23c (shown in FIG. 10) to condense the light. In order to increase brightness of the lamp, multiple light sources with multiple condenser lenses are applied in the lamp. For an objective of decreasing assembling cost, the light sources and the lens are manufactured in multiple condenser lens modules (shown in FIG. 11).

Please refer to FIG. 8. FIG. 8 illustrates a conventional collimator lens 21a and a conventional lens seat 10a. A containing slot 11a is established in the lens seat 11a. A containing hole 12a is disposed at one end of the containing slot 11a for covering a light source 20. A lens supporting surface 13a is disposed at the other end of the containing slot 11a for placing the collimator lens 21a. A focus between the light source 20 and the collimator lens 21a must be a correct height so that the light source 20 can project light having a correct condensing angle. However, a height of the above-mentioned lens seat 10a must be designed appropriately according to the light source 20 and the collimator lens 21a for achieving the correct focus. In other words, when the light source 20 or the collimator lens 21a is replaced, the lens seat 10a shown in FIG. 10 can not be used. The height of the lens seat 10a has to be re-designed.

Please refer to FIG. 9. FIG. 9 illustrates a conventional condenser cup 22b. A containing hole 12b is established in the condenser cup 22b for covering a light source 20. In order to project light having a correct condensing angle, a height of the condenser cup 22b must be designed according to characteristics of the light source 20. However, the light sources 20 manufactured by different manufacturers may be different. When the light source 20 is replaced but the condenser cup 22b is the same, this may result in an incorrect focus or an incorrect light angle.

Please refer to FIG. 10. FIG. 10 illustrates a conventional convex lens 23c and a lens seat 10c. A containing slot 11c is established in the lens seat 10c. A containing hole 12c is disposed at one end of the containing slot 11c for covering a light source 20. A lens supporting surface 13c is disposed at the other end of the containing slot 11c for placing the convex lens 23c. The convex lens 23c is utilized to condense light which is generated by the light source 20. In various environments, different heights of lens seat 10c are required for different applications of condensing angles. This results in expensive molding cost of the lens seat 10c.

Please refer to FIG. 11. FIG. 11 illustrates a conventional collimator lens module 21d and a conventional supporting board 32d. There exists a fixed distance between the collimator lens module 21d and the supporting board 32d. A plurality of light sources 20 which are manufactured in multiple condenser modules are fixed on the supporting board 32d. However, the light sources 20 manufactured by different manufacturers may be different. When the light source 20 is replaced but the condenser seat is the same, this may result in an incorrect focus or an incorrect light angle. That is, different light sources 20 can not share the collimator lens module 21d. Accordingly, there is a need to provide a new structure for improving the above-mentioned problems.

### SUMMARY OF THE INVENTION

A primary objective of the present invention is to provide an adjustable condenser seat capable of adjusting a focusing angle for different types of light sources and decreasing molding cost.

The adjustable condenser seat according to the present invention comprises at least one light source, at least one lens, at least one lens sleeve, and at least one adjuster. The lens sleeve contains the lens which is disposed for the light source correspondingly for guiding light from the light source to the lens. The adjuster is disposed at a focal axis of the light between the light source and the lens sleeve. The adjuster lengthens and shortens a distance between the light source and the lens for adjusting either a condensing angle of the lens or a focal position of the lens corresponding to the light source.

In one embodiment of the present invention, the adjustable condenser seat further comprises an automatic adjustment unit for driving the adjuster to be rotated, to lengthen or to shorten the distance between the light source and the lens. The automatic adjustment unit can automatically adjust either the condensing angle or the focal position of the lens corresponding to the light source for requirements in different environments.

In another embodiment of the present invention, the automatic adjustment unit is programmable to change light projecting effects.

Comparing the prior arts, the present invention has the following advantages. First, the adjuster can adjust the distance between the light source and the lens to change either the condensing angle of the lens or the focal position of the lens corresponding to the light source. As a result, the adjustable condenser seat of the present invention can be shared by different light sources so as to save molding cost. Second, by a plurality of operating modes of the automatic adjustment unit, the adjustable condenser seat can be controlled in different environments for the light source to produce various changes.

### BRIEF DESCRIPTION OF THE DRAWINGS

FIG. 1 illustrates an exploded stereographic view of a mechanism of the adjustable condenser seat according to a first embodiment of the present invention;

FIG. 2 illustrates an exploded stereographic view of a mechanism of the adjustable condenser seat according to a second embodiment of the present invention;

FIG. 3 illustrates an exploded stereographic view of a mechanism of the adjustable condenser seat according to a third embodiment of the present invention;

FIG. 4 illustrates an exploded stereographic view of a mechanism of the adjustable condenser seat according to a fourth embodiment of the present invention;

FIG. 5 illustrates an exploded stereographic view of a mechanism of the adjustable condenser seat according to a fifth embodiment of the present invention;

FIG. 6 illustrates an exploded stereographic view of an adjustable condenser seat according to a sixth embodiment of the present invention;

FIG. 7 illustrates an exploded stereographic view of an adjustable condenser seat according to a seventh embodiment of the present invention;

FIG. 8 illustrates a conventional collimator lens and a conventional lens seat;

FIG. 9 illustrates a conventional condenser cup;

FIG. 10 illustrates a conventional convex lens and a lens seat; and

FIG. 11 illustrates a conventional collimator lens module and a conventional supporting board.

### DETAILED DESCRIPTION OF THE INVENTION

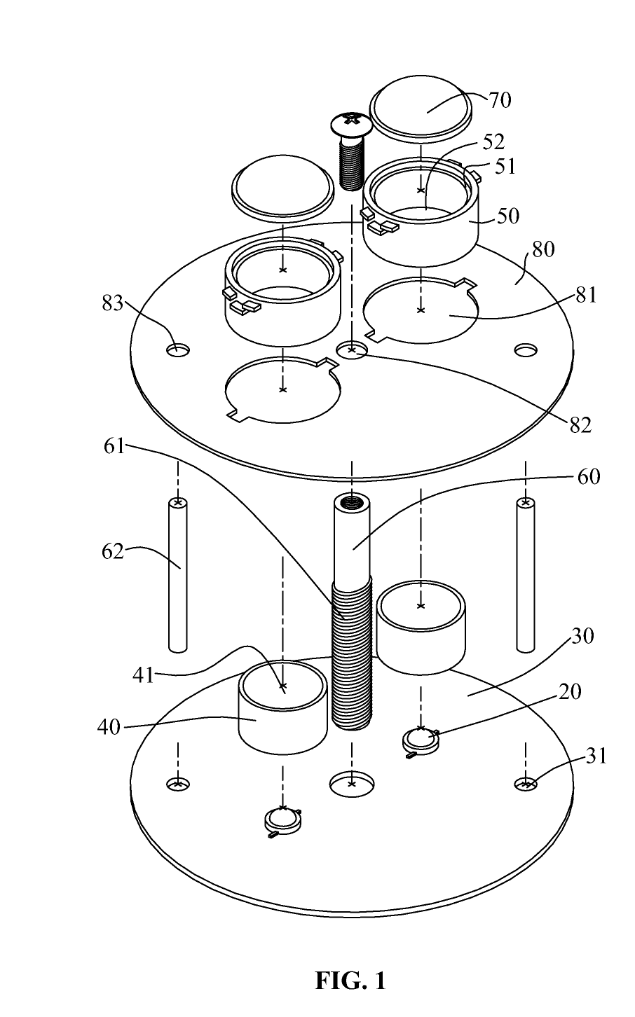

Please refer to FIG. 1. FIG. 1 illustrates an exploded stereographic view of a mechanism of the adjustable condenser seat 1 according to a first embodiment of the present invention. The mechanism of the adjustable condenser seat 1 mainly comprises at least one light source 20, at least one lens 70, at least one lens sleeve 50, and at least one adjuster 60. The light source 20, such as a light emitting diode (LED), is fixed on a supporting board 30. At least one light source sleeve 40, which is cylindrical, is disposed on the supporting board 30. The light source sleeve 40 has a hollow 41 therethrough. The light source sleeve 40 is hollow and tube-shaped for covering the light source 20 and guiding a path of light of the light source 20.

An assembling board 80 parallel to the supporting board 30 is disposed above a distance apart from the supporting board 30. The assembling board 80 has a containing hole 81 corresponding to the light source sleeve 40. The containing hole 81 is utilized to contain the lens sleeve 50. The lens sleeve 50 and the light source sleeve 40 can be jointed with each other.

A supporting hole 51 is disposed on the top of the lens sleeve 50 for containing the lens 70. A through hole 52 through the supporting hole 51 is disposed on the bottom of the lens sleeve 50. When the lens sleeve 50 and the light source sleeve 40 are jointed with each other, the lens sleeve 50 guides light of the light source 20 to the lens 70 for collecting the light of the light source 20.

At least one joint part 82, such as a hole, is disposed on the assembling board 80. The joint part 82 has an axis parallel a jointing direction of the lens sleeve 50 and the light source sleeve 40. The joint part 82 is utilized to joint to one end of the adjuster 60. The adjuster 60 has a motive portion 61 at the other end of the adjuster 60. The motive portion 61, for example, is a helical form, a gear rack, or a cylinder. The motive is utilized for being connected to a power source (not shown). Then, the power source can drive the adjuster 60 to rotate, lengthen, or shorten so as to lengthen or shorten a distance between the lens 70 and the light source 20. Therefore, a relative position between the lens 70 and the light source 20 can be adjusted, so that a condensing angle of the lens 70 can be changed or a focal position of the lens 70 corresponding to the light source 20 can be realized. In addition, a plurality of operating modes which are programmable are provided to automatically control the mechanism of the adjustable condenser seat 1. The operating modes will be described later in detail.

At least one limit path part (as a positioning element) 83, which is parallel in the jointing direction of the lens sleeve 50 and the light source sleeve 40, is disposed on the assembling board 80. The limit path part 83 is a hole, for example. At least one guide path part (as a positioning element) 31 is disposed on the supporting board 30 to correspond to the limit path part 83, and the guide path part 31 has the same axis as the limit path part 83. The limit path part 83 and the guide part 31 are utilized together for a path fixed part 62 to slide therethrough. When the adjuster 60 operates, the assembling board 80 can be steadily moved along the path fixed part 62 to change the relative position between the light source 20 and the lens 70. Therefore, there is no need to develop different heights of condenser seats.

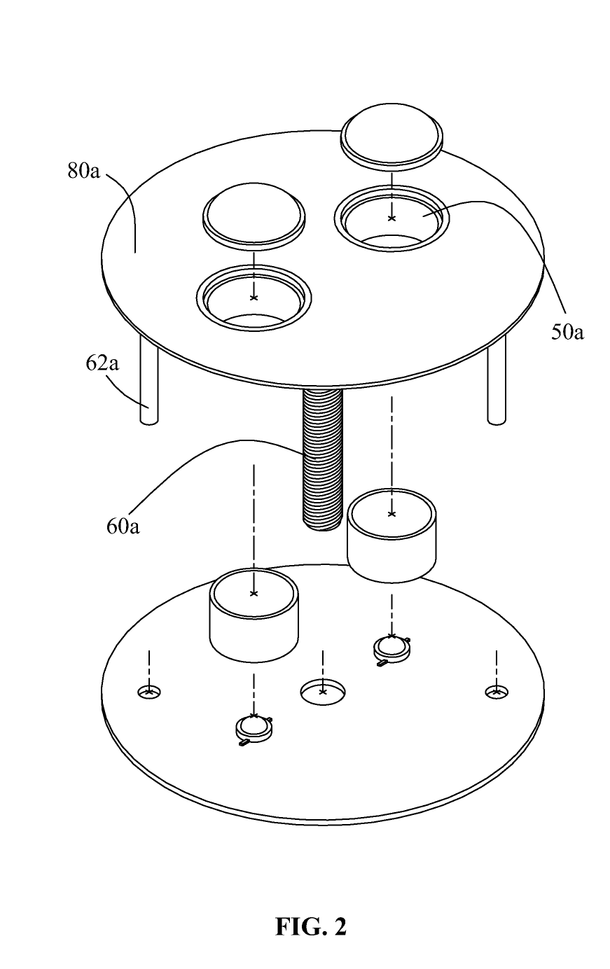

Please refer to FIG. 2. FIG. 2 illustrates an exploded stereographic view of a mechanism of the adjustable condenser seat 2 according to a second embodiment of the present invention. In the second embodiment, the lens sleeve 50a, the adjuster 60a, the path fixed part 62a, and the assembling board 80a are molded at an integral manner.

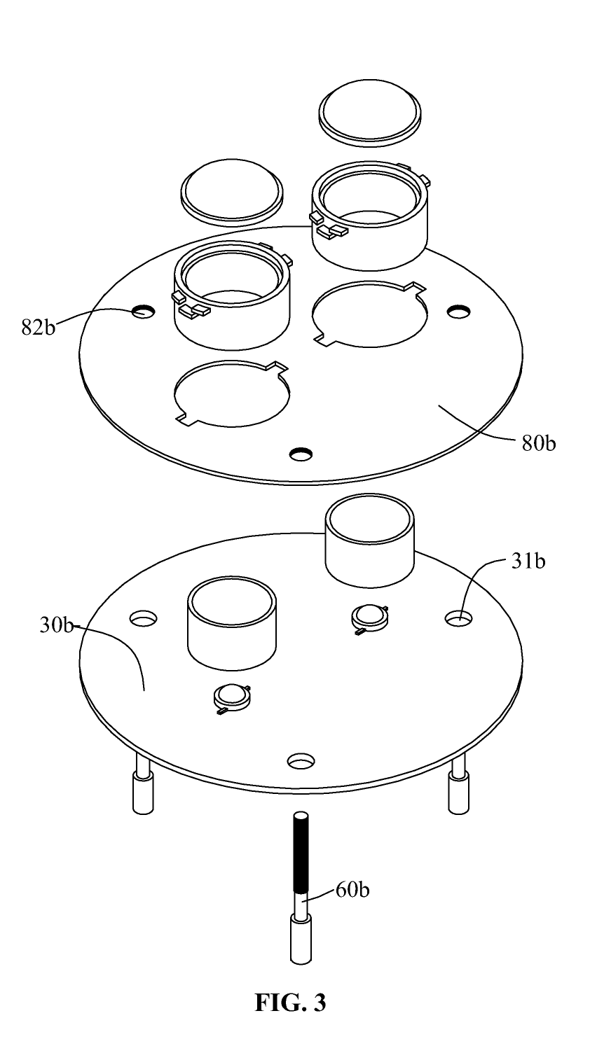

Please refer to FIG. 3. FIG. 3 illustrates an exploded stereographic view of a mechanism of the adjustable condenser seat 3 according to a third embodiment of the present invention. In the third embodiment, a plurality of adjusters 60b are symmetrically or asymmetrically disposed. A plurality of connecting parts 82b which has the same number as the adjusters 60b are disposed on the assembling board 80b. A plurality of guide path parts 31b corresponding to the connecting parts 82b are disposed on the supporting board 30b. The guide path parts 31b and the connecting parts 82b have the same axes. When the adjusters 60b operates, a distance between the assembling board 80b and the supporting board 30b can be lengthened or shortened along the adjusters 60b.

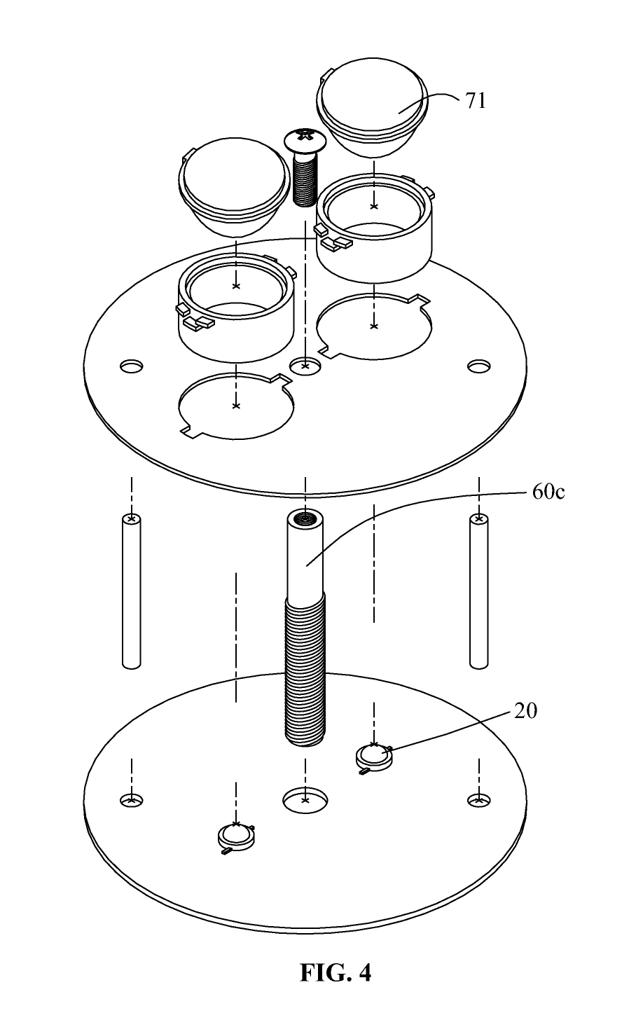

Please refer to FIG. 4. FIG. 4 illustrates an exploded stereographic view of a mechanism of the adjustable condenser seat 4 according to a fourth embodiment of the present invention. At least one collimator lens 71 is applied in the fourth embodiment. By adjusting an adjuster 60c, a correct focus between the collimator lens 71 and the light source 20 can be obtained. As a result, a problem such that different light sources 20 having various focuses can not share a condenser seat can be solved.

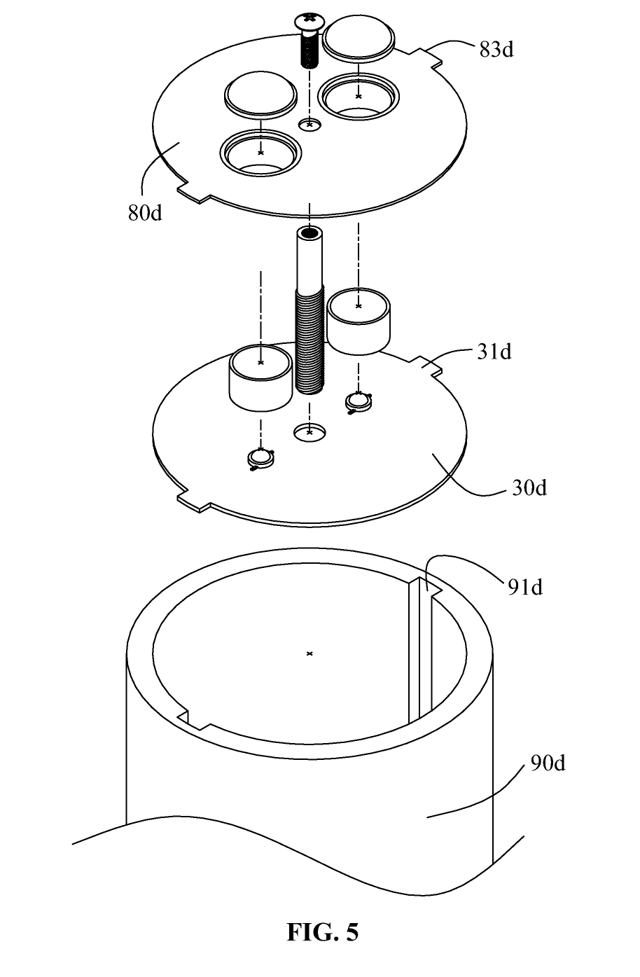

Please refer to FIG. 5. FIG. 5 illustrates an exploded stereographic view of a mechanism of the adjustable condenser seat 5 according to a fifth embodiment of the present invention. In the fifth embodiment, at least one limit path 91d which is slot-shaped is disposed on an inner surface of a lamp cover 90d. Shapes of both a limit path part 83d of an assembling board 80d and a guide path part 31d of a supporting board 30d are corresponding to a shape of the limit path 91d. The limit path part 83d and the guide path part 31d can be embedded in the limit path 91d so that a distance between the assembling board 80d and the supporting board 31d can be lengthened or shortened.

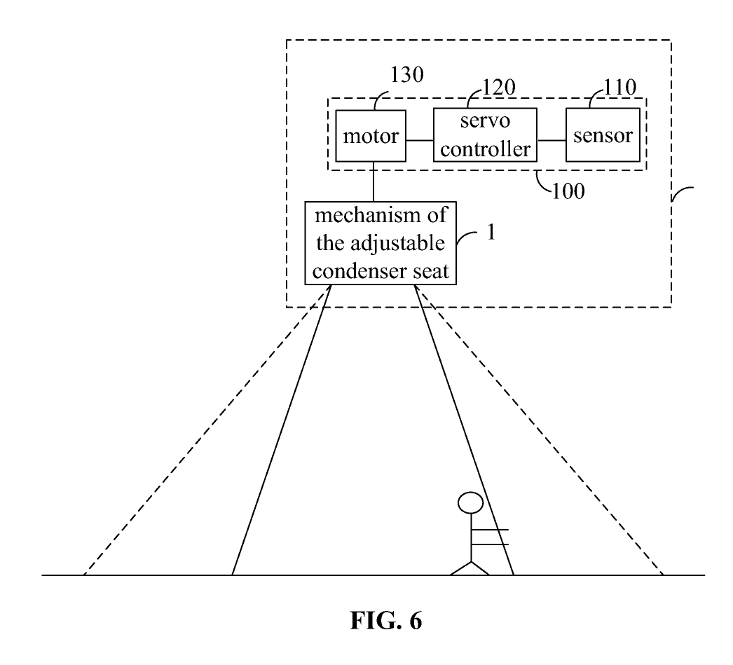

The following will describe embodiments having automatic adjusting functions. Please refer to FIG. 6. FIG. 6 illustrates an exploded stereographic view of an adjustable condenser seat 6 according to a sixth embodiment of the present invention. The adjustable condenser seat 6 comprises the mechanism of the adjustable condenser seat 1 and an automatic adjustment unit 100. The automatic adjustment unit 100 is utilized to drive a movable part of the mechanism of the adjustable condenser seat 1 to lengthen or shorten. The automatic adjustment unit 100 comprises a sensor 110, a servo controller 120, and a motor 130. A controlling signal such as a human hand triggers the sensor 110. Then the sensor 110 transmits the controlling signal to the servo controller 120. The servo controller 120 controls the motor 130 according to the controlling signal so that the motor 130 drives the movable part of the mechanism of the adjustable condenser seat 1 to change a condensing angle.

The above-mentioned automatic adjustment unit 100 has a plurality of operating modes. For example, after the sensor 110 is triggered, a current luminous range of the mechanism of the adjustable condenser seat 1 is changed and remains the changed status. Then, after the sensor 110 is triggered again, the luminous range of the mechanism of the adjustable condenser seat 1 is changed to another status. In another operating mode, for example, after the sensor 110 is triggered, the luminous range of the mechanism of the adjustable condenser seat 1 is changed. Then, after a specific time (e.g. 5 seconds), the luminous range of the mechanism of the adjustable condenser seat 1 recovers to the original status.

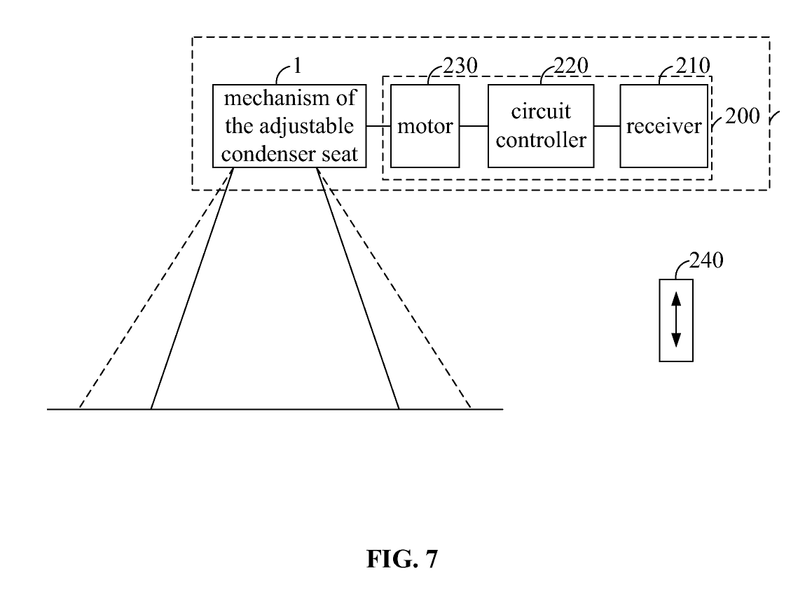

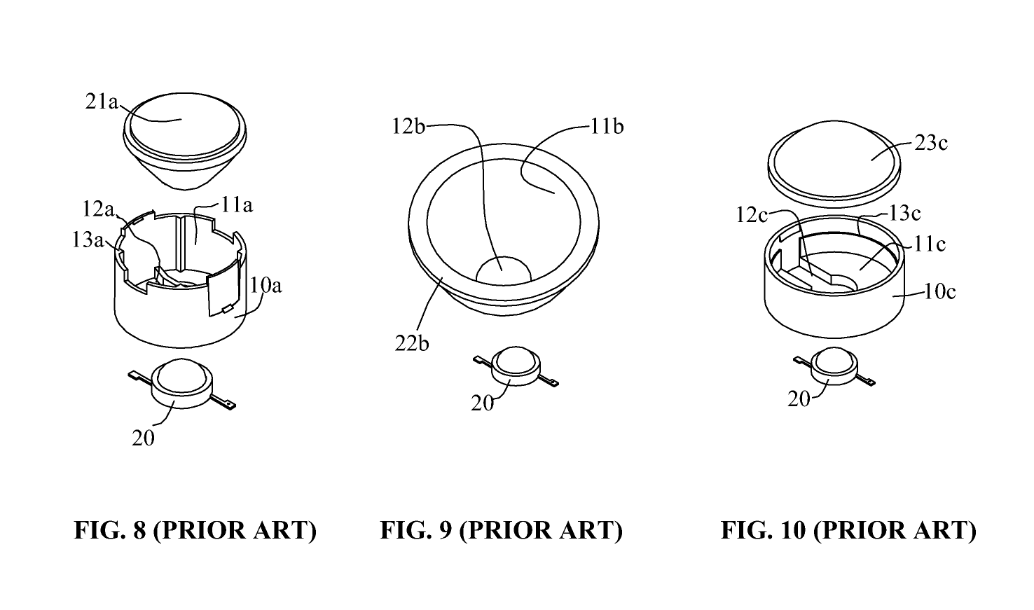

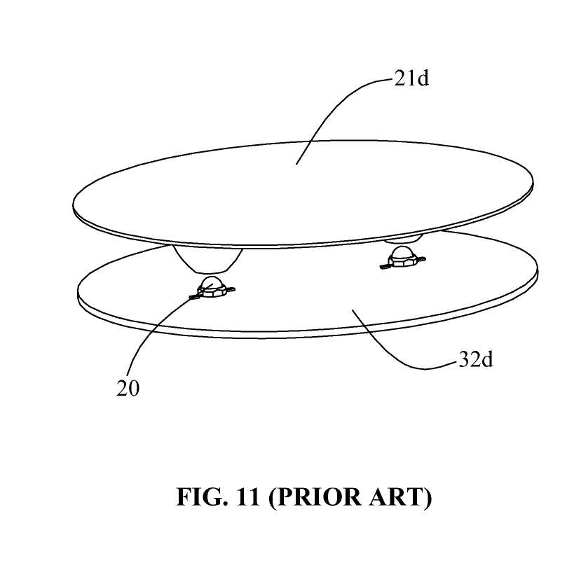

Please refer to FIG. 7. FIG. 7 illustrates an exploded stereographic view of an adjustable condenser seat 7 according to a seventh embodiment of the present invention. The adjustable condenser seat 7 comprises the mechanism of the adjustable condenser seat 1 and an automatic adjustment unit 200. The automatic adjustment unit 200 is utilized to drive a movable part of the mechanism of the adjustable condenser seat 1 to lengthen or shorten. The automatic adjustment unit 200 comprises a receiver 210, a circuit controller 220, and a motor 230. The receiver 210 receives a controlling signal which is generated by a remote controller 240. Then the circuit controller 220 controls the motor 230 according to the controlling signal so that the motor 230 drives the movable part of the mechanism of the adjustable condenser seat 1 to change a condensing angle.

Besides controlling a luminous range of the mechanism of the adjustable condenser seat 1 directly, the remote controller 240 further comprises a plurality of operating modes which are programmable for adjusting the luminous range of the mechanism of the condenser seat 1 and a luminous time of the mechanism of the adjustable condenser seat 1. For example, the luminous range of the mechanism of the adjustable condenser seat 1 is set in a larger status for a first specific time (e.g. 10 seconds). After the first specific time, the luminous range of the mechanism of the adjustable condenser seat 1 is automatically changed to a smaller status for a second specific time (e.g. 5 seconds). Finally, after the second specific time, the mechanism of the adjustable condenser seat 1 is automatically turned off.

It is noted that the automatic adjusting functions in the embodiments of FIGS. 6-7 can be applied to the embodiments of FIGS. 2-5 and are not repeated herein.

The adjustable condenser seat of the present invention utilizes the adjuster to adjust the distance between the light source and the lens for adjusting the condensing angle of the lens or the focus of the lens corresponding to the light source. As a result, the adjustable condenser seat can be shared by various light sources so as to decrease molding cost. Furthermore, by the various operating modes of the automatic adjustment unit, the light source can be controlled to produce various changes in various environments.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An adjustable condenser seat, comprising:
at least one light source;
at least one lens;
at least one lens sleeve for containing the lens which is disposed for the light source correspondingly for guiding light from the light source to the lens; and
at least one adjuster disposed at a focal axis of the light between the light source and the lens sleeve, wherein the adjuster is utilized for lengthening and shortening a distance between the light source and the lens to adjust either a condensing angle of the lens or a focal position of the lens corresponding to the light source.

2. The adjustable condenser seat of claim 1, further comprising an automatic adjustment unit for driving the adjuster to lengthen or shorten the distance between the light source and the lens.

3. The adjustable condenser seat of claim 2, wherein the automatic adjustment unit comprises:
a sensor;
a servo controller coupled to the sensor; and
a motor, coupled to the sensor and the adjuster, wherein the sensor is triggered by a controlling signal, and the servo controller controls the motor to drive the adjuster to lengthen or shorten.

4. The adjustable condenser seat of claim 2, wherein the automatic adjustment unit comprises:
a receiver;
a circuit controller coupled to the receiver; and
a motor, coupled to the receiver and the adjuster, wherein the circuit controller controls the motor according to a controlling signal, and the motor drives the adjuster to lengthen or shorten.

5. The adjustable condenser seat of claim 4, wherein the controlling signal is generated by a remote controller.

6. The adjustable condenser seat of claim 2, wherein the automatic adjustment unit has a plurality of operating modes for controlling the adjustable condenser seat.

7. The adjustable condenser seat of claim 1, wherein the lens sleeve is mounted to an assembling board for lengthening or shortening a distance between the assembling board and the light source.

8. The adjustable condenser seat of claim 7, wherein the assembling board further comprises at least one positioning element disposed thereon for the assembling board to lengthen or shorten in a straight-line manner.

9. The adjustable condenser seat of claim 8, wherein the assembling board and the positioning element are molded at an integral manner.

10. The adjustable condenser seat of claim 7, wherein the assembling board and the lens sleeve are molded at an integral manner.

11. The adjustable condenser seat of claim 1, wherein the light source is disposed on a supporting board for lengthening or shortening the distance between the light source and the lens.

12. The adjustable condenser seat of claim 11, wherein the supporting board further comprises at least one positioning element disposed thereon for the supporting board to lengthen or shorten in a straight-line manner.

13. The adjustable condenser seat of claim 1, wherein the light source further comprises at least one socket for jointing the lens sleeve.
